(19) United States
(12) Patent Application Publication
(10) Pub. No.: US 2009/0113362 A1
(43) Pub. Date: Apr. 30, 2009

(54) METHOD FOR DESIGNING A MASK FOR AN INTEGRATED CIRCUIT HAVING SEPARATE TESTING OF DESIGN RULES FOR DIFFERENT REGIONS OF A MASK PLANE

(75) Inventor: Ralf Lerner, Erfurt (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: X-FAB SEMICONDUCTOR FOUNDRIES AG

(21) Appl. No.: 11/997,603

(22) PCT Filed: Aug. 2, 2006
(86) PCT No.: PCT/EP2006/064927

§ 371 Date: Oct. 21, 2008

(30) Foreign Application Priority Data
Aug. 2, 2005 (DE) 10 2005 036 207.9

(51) Int. Cl. G06F 17/50

(52) U.S. Cl. 716/5; 716/19

(57) ABSTRACT

The invention relates to a method for designing integrated circuits, in particular a description and verification of design rules, wherein in one and the same process layer different design rules (6, 7) should be valid, for instance for a metallization layer for forming conductive lines in a high voltage smart power circuit, in which conductive lines (12, 13, 14) with different potentials are present. The method enhances area control, is efficient and results in a reduction of area consumption on the semiconductor wafer.

### CROSS REFERENCE TO RELATED APPLICATIONS

This application is a U.S. National Stage Application of International Application No. PCT/EP2006/064927, filed Aug. 2, 2006, which claims the benefit of European Patent Application No. DE 10 2005 036 207.9, filed on Aug. 2, 2005, the disclosure of which is herein incorporated by reference in its entirety. PCT/EP2006/064927 designated the United States and was not published in English.

### FIELD OF THE DISCLOSURE

Embodiments of the invention relate to a method for designing integrated circuits or associated process masks and also relates to an integrated circuit and a computer program with an instruction code for testing or correcting the designed layout (layout verification).

### BACKGROUND OF THE DISCLOSURE

U.S. Pat. No. 6,378,110 to Ho illustrates methods in which design layers (design levels) and valid design rules therefore are checked. This may be performed for each design layer and each associated design rule. In this case, in principle for each rule all of the associated design layers may be verified or the verification may be performed for a set of rules and a plurality of design layers.

If in one design layer different design rules are appropriate for the same situation for different regions of the later mask layout the accurate realization for a corresponding mask is more complex. The easiest way is to avoid the corresponding adaptation of the design rules for the different mask regions and to take into consideration only one design rule. The one design rule is then adapted to the most critical case and which covers the remaining conditions—by tolerating per se non-required additional effort during the later realization of the circuit. One specific example should be the metallization layer of a high voltage smart power circuit. In this case CMOS logic voltages (e.g. 3.3V) and also high voltage (e.g. 600V or higher) will be used. In order to prevent electrical breakthrough between conductive metal lines that are at different potentials, a corresponding minimum distance has to be maintained that is a part of the design rules and that may be up to a few micrometers at 600V, for example. This minimum distance required by the very high potential differences is significantly greater than the distance required by technology in other circuit portions. In such a circuit potential differences of several volts are encountered at the logic portion between the conductive lines, which allow significantly smaller distances of the conductive lines.

A high and a low potential may also be described as less than 10V (low) and greater than 100V (high), respectively.

U.S. Pat. No. 5,442,714 to Iguchi discloses a method in which the data of a design layer for a process mask of the completed circuit layout is divided into two data levels or levels A and B for the verification of the design rules. These two data levels are verified with respect to the corresponding design rules A, B and AB. The two data levels A and B are subsequently processed into a single photolithographic mask. In this method the separation into two data levels is performed during the verification of the design rules only. The actual layout comprises data for a process mask in one single data level.

This method is complex and does not absolutely ensure control of the design layer. Hence, a further layout test is required. Any errors may be detected on the completed layout only, which means a significant effort for any required correction.

Japanese Patent JP-A 02-93984 discloses a method for designing integrated circuits in which the design layer used for a process mask layer is divided into several design layers 1 to n, which are combined to an overall layer L. In this method the design rule verification (DRC, design rule check) is performed in the combined overall layer L and thus any errors may be detected after the completion of the entire layout only.

These and other drawbacks exist.

### OBJECTS OF THE DISCLOSURE

It is therefore an object of the invention to provide a qualitatively enhanced control-secure method in which, depending on external influential parameters, different design rules may be used for one and the same process mask layer, wherein the area consumption on the wafer may significantly be reduced.

### SUMMARY OF THE INVENTION

According to various embodiments of the invention, a method for designing an integrated circuit is provided in which a design layer used for a process mask layer is divided into a plurality of design layers. For each of these design layers at least one associated design rule is valid and the design rules of each of the individual design layers is individually verified in a design rule check or verification in a single method step. Thereafter, the plurality of verified design layers may be combined to one single data level. Subsequently, a single process mask may be produced from this combined data level.

The inventive method enables a determination of different design rules for the same situation depending on external influential parameters for a design rule and to more easily verify them on the basis of a plurality of these associated separated design layers. Moreover, it is possible to significantly reduce the area consumption of the devices when the design rules relate to the geometrical characteristics of polygons, representing the devices of an integrated circuit, and to the mutual geometrical relations.

In some embodiments it may be advantageous in the inventive method that each of the (separated) design layers is used in the overall circuit layout.

### BRIEF DESCRIPTIONS OF TUE DRAWINGS

Various embodiments of the invention will be described in more detail while referring to the drawings. In the drawings

FIG. 1 illustrates a portion of only one design layer of the metallization of a high voltage smart power circuit according to the prior art.

FIG. 2 illustrates a portion of a first design layer and a portion of a second design layer of the metallization of a high voltage smart power circuit according to an embodiment of the invention.

FIG. 3 illustrates a portion of the process mask of the metallization layer according to FIG. 2.

FIGS. 4a and 4b represent in a symbolic manner the two design levels NV (low voltage layer) and HV (high voltage layer) which are both illustrated in FIG. 2 so as to have a respective design distance 6, 7. The distance 7 refers to the low voltage layer, the distance 6 that is greater refers to the high voltage layer. These two layers are logic design layers. They are combined into a data level for the fabrication of the mask, as is represented in a symbolic manner in FIG. 2.

FIG. 5 is a section through an integrated circuit, wherein different metallization layers are illustrated.

### DETAILED DESCRIPTION OF THE DISCLOSURE

The following description is intended to convey a thorough understanding of the embodiments described by providing a number of specific embodiments and details involving a method for designing a mask for an integrated circuit having separate testing of design rules for different regions of a mask plane. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

At the beginning of the manufacturing process for semiconductor circuits, initially a circuit layout is designed by which the function of the semiconductor circuit is determined. The layout determines the physical realization of the circuit on a silicon wafer. Conventional methods for fabricating the circuit on the wafer are based on lithography. Among others, the circuit layout is initially imaged onto a mask and is subsequently imaged on the wafer by exposing the mask.

The fabrication of a chip involves many steps, wherein each of the manufacturing steps includes an uncertainty which ideally should already be taken into consideration when designing the layout. For this purpose, design rules are provided that are to be taken into consideration during the layout design so as to ensure the later functional behaviour of the layout. For instance, such layout rules may determine the minimum distance between two transistors or the width of metal lines. After completing the circuit layout the layout is verified by software with respect to meeting the design rules and is corrected, if required. This step is referred to as “verification” and is performed by a computer.

The circuit layout comprises the required data for manufacturing the various photolithographic masks. These masks are used for patterning the various layers in the semiconductor manufacturing process.

In some embodiments it may be advantageous that each of the (separated) design layers is used in the overall circuit layout. By the “separation” of the design layer for the process mask layer into the plurality of design layers, which is usually the case, it is meant a condition in which it is worked with a plurality of design layers. In the plurality of design layers the corresponding layout is separately designed so that the division or partitioning is a separation. In other words, there are provided two separate design layers, or “is separated into these design layers”, in each of which at least one associated design rule is valid. This is more clearly expressed when a plurality of design layers is already provided in a separated state, which is previously obtained when establishing the design documents—establishing the concept and the like. The separation of the one design layer may therefore occur in advance or one begins with it when the layout is performed in the respective discrete design layer.

In some embodiments, when the process mask layer corresponds to a metallization layer for the fabrication of conductive lines in a high voltage smart power circuit—in which the conductive lines are provided and are appropriate for different potentials—the conductive lines for high potential may be designed in a first design layer and conductive lines for a low potential may be designed in a second design layer. Each of these design layers has a valid design rule associated with it. The design rules may be different from each other. Hence, the area consumption of the conductive lines may be reduced to a minimum.

The high and the low voltage is to be understood in the manner as is explained with respect to the prior art.

In some embodiments, the two design layers, for which at least one design rule is valid and these at least two rules are not identical, may preferably be valid for the same metallization layer for forming conductive lines in a high voltage smart power circuit.

In some embodiments, a geometrical relation and in particular a minimum distance between the conductive lines of a high voltage smart power circuit is determined as a design rule so as to prevent electrical breakthroughs between the conductive lines which are at different potential during operation of the circuit.

In some embodiments, it may be advantageous to determine, as a design rule, a greater first minimum distance between conductive lines, of which at least one is provided for high potential and which are designed in a first design layer, compared to a second minimum distance between conductive lines that are exclusively provided for a low potential and that are designed in a second design layer.

In some embodiments, the first and second design layers are formed or combined into a single photolithographic process mask in a single process layer. Additional layers, that is, also a third and a fourth layer, may be added. The first and second layers are merely labels and do not represent any restriction with respect to their number.

According to some embodiments of the invention an integrated circuit having an overall circuit layout may be provided in which the overall circuit layout may consist of a plurality of separated design layers that may be verified with respect to their respective associated own design rules. These individual verified design layers can be combined to a single data level so as to form a single process mask. The separated layers may have been separated at an earlier stage when establishing the design documents, the conception and the like. They may also be provided as respective appropriate/separated layers.

In some embodiments, a computer program including an instruction code may be provided for performing the inventive method when the instructions are executed by a computer.

According to some embodiments of the invention, a method for designing an integrated circuit is provided, in which the design layer used for a process mask layer is provided as a plurality of separate design layers (is divided). For each of these design layers appropriate or own design rules, which are valid, may be verified individually during the design rule check or verification. Thereafter, the plurality of verified design layers may be combined into a single data level. Thus, a single process mask may be formed from this combined data level. Each of these design layers may be used in the overall layout.

It should be noted that similar components in the figures are denoted by the same reference signs. Elements illustrated in the drawings are not true to scale.

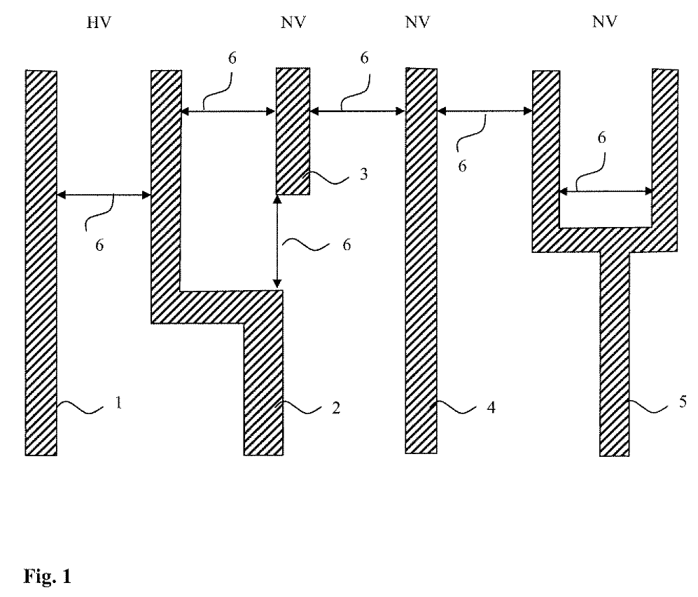

FIG. 1 illustrates a portion of a single design layer of the metallization of a high voltage smart power circuit according to the prior art. The design layer comprises a first conductive line 1 and a second conductive line 2 for high potential HV and also comprises a first conductive line 3, a second conductive line 4 and a third conductive line 5 for low potential NV. The high potential requires a large minimum distance between the conductive lines so as to avoid electrical breakthrough between the conductive lines that correspond to different potentials. As is evident from FIG. 1 the minimum distance 6 between the conductive lines 1, 2, 3, 4 and 5 that corresponds to different potentials is the same everywhere and corresponds to that as used for the higher voltage of the HV layer.

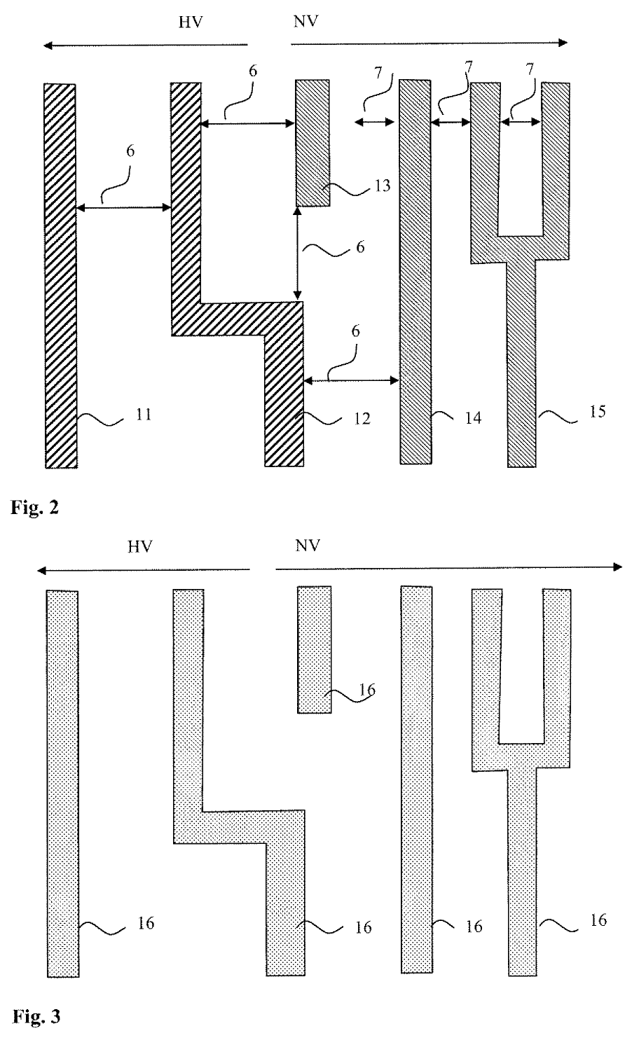

FIG. 2 illustrates a portion of a first design layer and a portion of a second design layer of the metallization of a high voltage smart power circuit according to an embodiment of the invention.

In some embodiments, a separation of the design layers from one design layer does not necessarily need to represent an actual step of the method, wherein the single design layer is provided for the process mask. The layers in which the layout is created may also be separated per se in the sense of “divided or separated” design layers. Thus, there could be a situation where there was no separation step required. The separation may have been obtained when a separated design layer is worked with. In other words, the separation into several design layers may have been performed earlier when establishing the design documents (the conception and the like) with respect to the integrated circuit; in particular, with respect to the process mask layer for the metallization layer, in which the conductive lines are provided.

Conductive lines 11 and 12 may be provided for high potential HV (and for this reason are “appropriate”) and may be designed in a first design layer relating to the metallization layer. In this case, the minimum distance 6 between the conductive lines 11 and 12 is determined as one of for example several design rules.

As far as is also referred to conductive lines, these may be representatives in the form of data of these conductive lines, which are actually formed by imaging the mask of the mask layer during a lithography process. For instance, when physically realizing the circuit on a wafer. That is, in the metallization layer (i.e. at the point in time in which the metallization layer is transferred into the device via lithography). For a better understanding it is herein referred to conductive lines 11, 12, respectively (high voltage layer HV), or conductive lines 13-15, respectively (low voltage layer NV), whereas their respective representatives in the corresponding logic design layer are meant. These representatives are structures which correspond in their shape to the later structures in the metallization layer of the semiconductor wafer so as to contribute to the realization of the integrated circuit. These structures on the mask may deviate in their size from the real structures while, however, the shape remains so that a mathematical similarity exists. For example, for an exposure 1:1 the structure of the mask would identically be transferred into the structure of the metallization layer, for a 5:1 exposure the mask structures would be reduced by a factor of 5 on the wafer, for instance when exposed in the metallization layer.

In some embodiments, there may be a plurality of metallization layers on the wafer. For example one layer up to 10V, one for 100V, a further one for 300V and still a further one for the usage in the context of voltages above 300V. Similar to the case in which several layers are provided, also several different voltages per layer are possible, wherein in this case the metallization layer is meant as the layer. The three exemplary layers are not limiting but are a further example of how to design several layers each in an individual manner and how these layers are to be subjected to verification in the layout.

In a second design layer that corresponds to the metallization layer the conductive lines 13, 14 and 15 are designed, which are at a low potential NV (during operation). A significantly reduced minimum distance 7 is determined and used between the conductive lines 12, 13 and 14 as a different one of several design rules that are valid in this case, thereby resulting in a significant reduction of the area consumption of the later mask and conductive lines.

The first rule and the different rule are not identical. In the example illustrated, the minimum distance 7 is less with respect to the conductive lines, which may be positioned more closely to each other in the metallization layer of the completed device, and with respect to minimum distances 6 that are valid as a rule for the high voltage layer and which are associated with the conductive lines that are formed in the high voltage layer during the replication via the mask and the lithography method in the metallization layer.

In some embodiments, for the fabrication of the photolithographic mask, the two design layers may be combined to a single data level for the mask layer.

Upon combining the two design layers the greater minimum distance 6 between the adjacent conductive lines, in this case the conductive lines 6 and 13 or 14, having a different potential, is maintained, as is illustrated in FIG. 2.

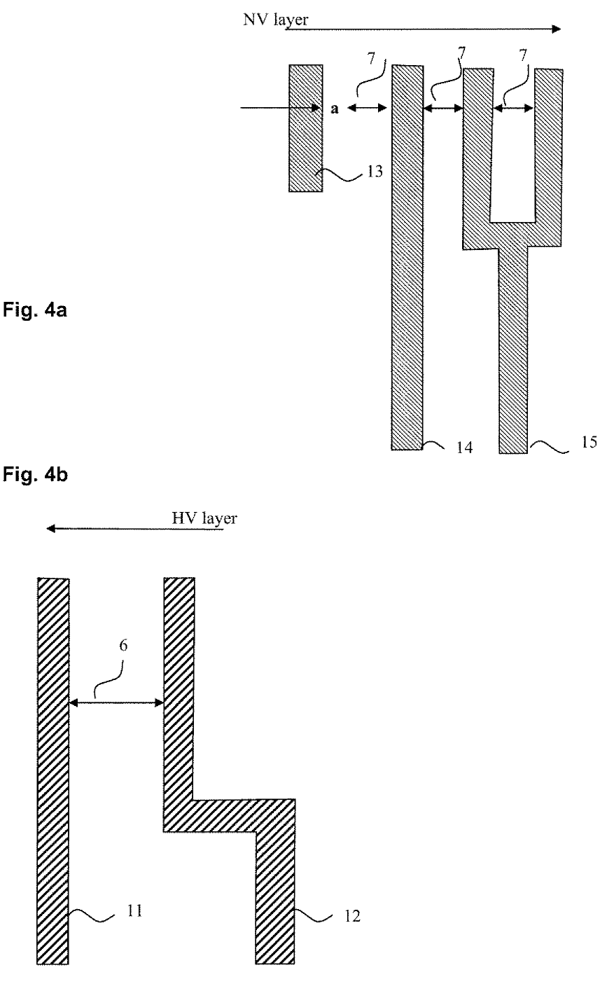

FIG. 3 illustrates the design rules combined into a single process layer (not shown) by means of a single photolithographic process mask (not shown) during the fabrication process, wherein all of the conductive lines 16 of the photomask have the minimum distances 6 and 7, respectively, as are shown in FIG. 2 and as explained above. These minimum distances are different in portions and are designed separately, which separation is shown by the two design layers of FIG. 4a (low voltage layer) and FIG. 4b (high voltage layer). The corresponding design rule is evident there. For instance having the lines 11, 12 in the high voltage layer and having for example three lines or a split Y-like line in the low voltage layer of FIG. 4a. The exception in the adjacent portion is the increased distance 6 for those lines 14, 12, that are adjacent in FIG. 2 (which are directly adjacent). The adjacent conductive lines are those that are exactly opposite to each other so that they are actually the conductive lines 12 and 13, while another conductive line 14 is the closest and most adjacent conductive line of the low voltage layer with respect to the last conductive line of the high voltage layer at the location where the conductive line 13 terminates. For this, if desired, staggered sequence of adjacent conductive lines commonly the transition scaling rule is valid according to which the increased distance 6 is to be met by all conductive lines with respect to the high voltage layer that may be positioned at the outer boundary of the low voltage layer and which may be adjacent to an outer boundary of the high voltage layer.

The DRC (as design rule) defines the explained minimum distances, for example. A distance between the conductive line 13 and the conductive line 14 may be at least as large as is indicated by the distance arrow 7 in FIG. 2. This holds true when considering a corresponding reduction or enlargement during the imaging of the mask layer into the wafer of a corresponding size on the mask layer. In the example an imaging ratio of 1:1 is to be assumed and the structures that are subjected to the layout in the mask layer are correspondingly also referred to as “conductive line” although they merely represent the representatives. The mentioned distance 7 in FIG. 2 provided between the upper portion of the conductive line 14 and the shorter conductive line 13 may be selected larger, if desired. In the illustrated application the conductive line 13 could also be shifted further to the right, thereby obtaining an increased distance with respect to the conductive line 12 (the upper section thereof), and the increased distance is greater than the minimum distance of the second design rule for the high voltage layer. Thereby, also further embodiments may be obtained for the design of the conductive line 13 positioned between the high voltage layer (the illustrated high voltage area, for example in the metallization layer) and the low voltage area corresponding to the low voltage design layer.

If the conductive line 13 is designed as a shorter part further to the right within the layout the design rule that is further valid at the right hand side has to be obeyed. That is, the distance 7 must not be fallen short of. In this case, the distance 6 is also not fallen short of (to the left of the conductive line 13) so that both design rules are met.

For the conductive line 13 to be positioned in the layout also a plurality of possibilities is provided due to the illustrated angled shape of the conductive line 12, wherein the possibility corresponding to the line positioned farthest to the left is illustrated and is correspondingly the variant positioned farthest to the right where the right edge of the conductive line 13 abuts the left end of the arrow of the indicated distance 7.

For the upper portion of the layout in FIG. 2 it follows that either between the conductive lines 12, 13 or between the conductive lines 13 and 14 or between both pairs of conductive lines increased distances are obtained compared to the given minimum distances 6 and 7. Both verifications are thus fulfilled, several layouts are possible and the required space occupied is not to be considered inferior for each of the several possible layouts.

The minimum distance 6 in the lower portion between the conductive lines 12, 13 determines the requirement, here the distance 6 may be provided as a minimum distance between the high voltage region and the low voltage region, while the shorter conductive line 13 has several possibilities for the layout in the further upwardly positioned area.

The mentioned “transition scaling rule” may also be significantly more tolerant and allows, depending on the routing of the conductive lines, several designs. This transition scaling rule is determined by the high voltage region and the corresponding high voltage layer which requires its minimum distance 6 to be selected so as to be maintained at least by the conductive line positioned utmost outwardly of the low voltage layer (of the low voltage region in the semiconductor). In other words, the design rule is valid for both the high voltage layer and also for the transition area to the low voltage layer. It follows that the distance “a” in FIG. 4a provides a margin within which all design rules of both layers will further be met.

In some embodiments, a computer program including an instruction code comprises the verification of each individual one of the separately designed design layers. The first rule and at least one additional rule deviating therefrom relate to the design layers and the program may verify the designed layout of the first design layer associated with the at least one design rule. The program may also verify the second design layer having the at least one other design rule so as to make these separately verified design layers usable for a combination into a single combined data level.

This may result in an integrated circuit that may also be processed and fabricated by other process steps, but, among others, comprises the metallization layer stemming from the overall circuit layout of the plurality of design layers that have been separately treated and separately verified. Each design layer may be verified with its at least one design rule and both indicated design rules may be different.

If additionally other parameters of the design rules are present then this may absolutely be the case. They need not necessarily be different, but at least one rule deviates so that the two sets of design rules for the one high voltage layer and the other low voltage layer may be considered as not identical.

In the example these are, for instance, the distances of the conductive lines. Other design rules may relate to the width of the conductive lines.

FIG. 5 illustrates a cross-section of an integrated circuit wherein different metallization layers are illustrated.

### REFERENCE SIGNS

1 First conductive line at high potential in a single design layer (metallization layer)

2 Second conductive line at high potential in a single design layer (metallization layer)

3 First conductive line at low potential in a single design layer (metallization layer)

4 Second conductive line at low potential in a single design layer (metallization layer)

5 Third conductive line at low potential in a single design layer (metallization layer)

6 Minimum distance for conductive lines at high potential

7 Minimum distance for conductive lines at low potential

11 First conductive line at high potential in a first design layer (metallization layer)

12 Second conductive line at high potential in a first design layer (metallization layer)

13 First conductive line at low potential in a second design layer (metallization layer)

14 Second conductive line at low potential in a second design layer (metallization layer)

15 Third conductive line at low potential in a second design layer (metallization layer)

16 “Conductive lines” on a photomask.

Accordingly, the embodiments of the present inventions are not intended to be limited in scope by the specific embodiments describe herein. Thus, modifications are intended to fall within the scope of the following appended claims. Further, although some of the embodiments of the present inventions have been described herein in the context of a particular implementation in a particular environment for a particular purpose, those of ordinary skill in the art should recognize that its usefulness is not limited thereto and the embodiments of the present inventions can be beneficially implemented in any number of environments for any number of purposes. Accordingly, the claims set forth below should be construed in view of the full breadth and spirit of the embodiments of the present inventions as disclosed therein. While the foregoing description includes many details and specificities, it is to be understood that these have been included for purposes of explanation only, and are not to be interpreted as limitations of the inventions. Modifications to the embodiments described above can be made without departing from the spirit and scope of the invention.

1. A method for designing an integrated circuit or fabricating a process mask for such an integrated circuit,
comprising:
separating at least one design layer used for a process mask layer into a plurality of design layers, wherein each separate design layer is associated with at least one design ruler;
separately verifying the validity of each of the respective at least one design rules in a design rule verification which corresponds to each of the at least one design layers;
combining the plurality of verified design layers into a single data level,
whereby a process mask corresponding to the verified design layers is produced from the combined data level.

2. The method according to claim 1, wherein each of the separate design layers is used in the overall circuit layout.

3. The method according to claim 1, wherein the process mask layer is a metallization layer for fabricating conductive lines in a high voltage smart power circuit in which the conductive lines provide for different potentials,
wherein the conductive lines for high potential are designed in a first design layer and conductive lines for low potential are designed in a second design layer, and
wherein for each of these design layers at least one design rule is valid and the design rules are not identical.

4. The method according to claim 3, further comprising:
determining a minimum distance between the conductive lines as a design rule, whereby the minimum distance between conductive lines prevents electrical breakthrough between conductive lines that are at different potentials,
wherein the minimum distance is determined between conductive lines configured for low potential.

5. The method according to claim 4, further comprising:
determining a greater minimum distance between conductive lines as a design rule, wherein at least one of the two conductive lines is configured for use with high potential,
wherein the at least one high potential conductive line is designed in a first design layer, and
wherein the low potential conductive lines, which were used in the determination of a minimum distance, are designed in a second design layer.

6. The method according to claim 3, wherein a first design layer and a second design layer are fabricated in a single process layer with a single photolithographic process mask.

7. The method according to claim 3, wherein the two design layers are valid for the same metallization layer.

8. An integrated circuit comprising:
a plurality of separated design layers, wherein the plurality of separated design layers are verified according to associated design rules,
a single process mask, wherein the single process mask is formed by coming separately verifiable design layers into a single data level,
wherein the process mask is configured to contribute during a fabrication of the integrated circuit.

9. A computer program including an instruction code stored on a computer readable medium for performing the method according to claim 1, wherein the program is configured to be executed by a computer.

10. A method for designing integrated circuits, comprising:
separating the design layer used for a process mask into several design layers;
providing an associated design rule for each of the design layers;
performing design rule verification to individually verify the validity of each design rule;
combining the several verified design layers to a single data level; and
fabricating, from the combined single data level, a single process mask having an overall layout,
wherein each of these design layers is used in the overall layout.

11. The method according to claim 10, wherein the at least two design rules are not identical for at least two design layers.

12. The method according to claim 1, wherein the at least two design rules are not identical.

13. The method according to claim 6, wherein more than two design rules are provided.

14. The method according to claim 3, wherein in a transition area in which both layers are directly adjacent to each other, the design rules of the first layer for the higher voltage is commonly valid also for the conductive line of the second design layer for the low voltage.

15. The method according to claim 14, wherein the common validity is restricted to the outermost conductive line of the second layer and its relation to the first layers.

16. The method according to claim 10, wherein the design layers relate to the metallization layer in the wafer,
